(19) United States
(12) Patent Application Publication
(10) Pub. No.: US 2024/0211563 A1
(43) Pub. Date: Jun. 27, 2024

(54) USER AUTHENTICATION USING COMBINATION OF VOCALIZATION AND SKIN VIBRATION

(71) Applicant: Meta Platforms Technologies, LLC

(72) Inventors: Morteza Khaleghimeybodi, Bothell, WA (US); Mohamed Tarek Ahmed El-Haddad, Redmond, WA (US); Gizem Tabak, Champaign, IL (US)

(21) Appl. No.: 18/086,549

(22) Filed: Dec. 21, 2022

Related U.S. Application Data
(60) Provisional application No. 63/302,927, filed on Jan. 25, 2022.

(51) Int. Cl. G06F 21/32; G10L 17/24

(52) U.S. Cl. CPC G06F 21/32; G10L 17/24

(57) ABSTRACT

An audio system configured to authenticate a user. The system detects, via a microphone array, airborne acoustic waves corresponding to a vocalization of a user. The system also detects, via a vibration measurement assembly, vibration of tissue of the user caused by the vocalization. The system generates an authentication dataset using the detected airborne acoustic waves and the detected vibration of tissue. The system may authenticate the user based in part on the authentication dataset.

### CROSS REFERENCE TO RELATED APPLICATION

This application claims priority to U.S. Provisional Patent Application Ser. No. 63/302,927, entitled “User Authentication Using Unique Individualized Audio Filters,” filed Jan. 25, 2022, which is incorporated by reference in its entirety.

### FIELD OF THE INVENTION

The present disclosure generally relates to user authentication, and specifically relates to user authentication using unique combinations of vocalizations of users and skin vibrations of users caused thereby.

### BACKGROUND

Authentication is the process of identifying and verifying the identity of a person in a secure manner. Voice biometrics is the science of using a person's voice as a uniquely identifying characteristic in order to authenticate them, and they can enable fast and frictionless access for a range of use cases. However, solely using voice biometrics may not be safe as one person can easily hack another person's voice (either through computer generation, or by impersonating their voice) in order to hack the device. Accordingly, there is a security concern with voice-only activation authentication systems.

### SUMMARY

There is a security concern with voice-only activation authentication systems because one can easily hack another's voice either through computer generation or by impersonating. Principles described herein solve the above-described problem by using a unique combination of vocalization of a user and vibration of tissue of the user caused by the vocalization to authenticate the user.

In some embodiments a method is described. The method includes detecting, via a microphone array, airborne acoustic waves corresponding to a vocalization of a user; and detecting, via a vibration measurement assembly, vibrations of tissue of the user caused by the vocalization. An authentication dataset is then generated based on the detected airborne acoustic waves and the detected vibrations of tissue. The user is authenticated based in part on the authentication dataset.

In some embodiments, a non-transitory computer-readable storage medium is described. The non-transitory computer-readable storage medium includes stored instructions, that when executed by a processor of a device, cause the device to detect, via a microphone array, airborne acoustic waves corresponding to a vocalization of a user. The execution of the instructions also cause the device to detect, via a vibration measurement assembly, vibrations of tissue of the user caused by the vocalization, and generate an authentication dataset based on the detected airborne acoustic waves and the detected vibrations of tissue. The execution of the instructions also cause the device to authenticate the user based in part on the authentication dataset.

In some embodiments, a system is described. Embodiments related to a system configured to authenticate a user based on a unique combination of vocalization of a user and vibrations of tissue of the user caused by the vocalization. The system detects, via a microphone array, airborne acoustic waves corresponding to a vocalization of a user. The system also detects, via a vibration measurement assembly, vibration of tissue of the user caused by the vocalization. The system generates an authentication dataset using the detected airborne acoustic waves and the detected vibration of tissue, and authenticates the user based in part on the authentication dataset.

### BRIEF DESCRIPTION OF THE DRAWINGS

FIG. 1A is a perspective view of a headset implemented as an eyewear device, in accordance with one or more embodiments.

FIG. 1B is a perspective view of a headset implemented as a head-mounted display, in accordance with one or more embodiments.

FIG. 2 is a block diagram of an authentication system, in accordance with one or more embodiments.

FIG. 3 illustrates a block diagram of an authentication process based on a unique combination of vocalization of a user and vibrations of tissue of the user caused by the vocalization, in accordance with one or more embodiments.

FIG. 4A illustrates a diagram visualizing audio data and vibration data corresponding to a first user (also referred to as “subject 1”), in accordance with one or more embodiments.

FIG. 4B illustrates a diagram visualizing audio data and vibration data corresponding to a second user (also referred to as “subject 2”), in accordance with one or more embodiments.

FIG. 4C illustrates a diagram visualizing audio data and vibration data corresponding to a third user (also referred to as “subject 3”), in accordance with one or more embodiments.

FIG. 5 is a diagram of example relationships between audio frequencies and vibrations corresponding to the first user, the second user, and the third user of FIGS. 4A, 4B, and 4C, in accordance with one or more embodiments.

FIG. 6 is a flowchart of a method for authenticating a user based on a unique combination of vocalization of a user and vibrations of tissue of the user caused by the vocalization, in accordance with one or more embodiments.

FIG. 7 is a system that includes a headset, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Authentication is the process of identifying and verifying the identity of a person in a secure manner. Voice biometrics is the science of using a person's voice as a uniquely identifying characteristic in order to authenticate them, and can enable fast and frictionless access for a range of use cases. However, using voice biometrics solely may not be safe as someone can easily hack someone else voice (either through computer generation, or by impersonating their voice) in order to hack the device. Accordingly, there is a security concern with voice-only activation authentication systems.

A combination of vocalization of a user and vibrations of tissue of the user caused by the vocalization is sufficiently unique for authentication purposes. Embodiments described herein related to a system configured to authenticate a user based on a unique combination of vocalization of the user and vibrations of tissue of the user caused by the vocalization. The system detects, via a microphone array, airborne acoustic waves corresponding to a vocalization of a user. The system also detects, via a vibration measurement assembly, vibration of tissue of the user caused by the vocalization. The system generates an authentication dataset using the detected airborne acoustic waves and the detected vibration of tissue, and authenticates the user based in part on the authentication dataset.

Many devices have voice activation functions that allow users to activate the devices via a wake word. However, after the device is activated, users are often still required to perform additional steps to authenticate themselves, such as entering a password, providing fingerprint, etc. Voice authentication described herein eliminate the requirement of such additional authentication steps. For example, a same wake word can be used to both activate a device and authenticate a user, providing convenience for the user. Additionally, a user's voice can be authenticated periodically, improving device security.

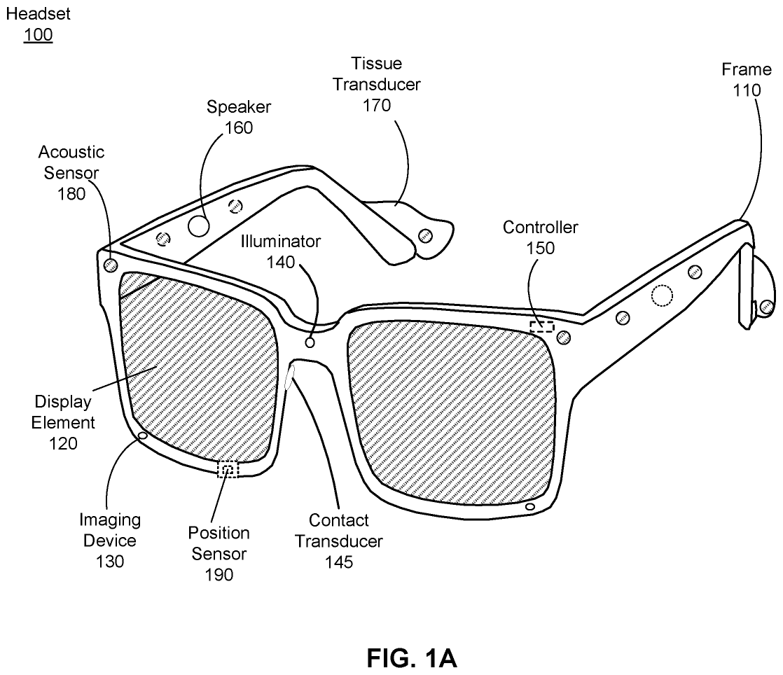

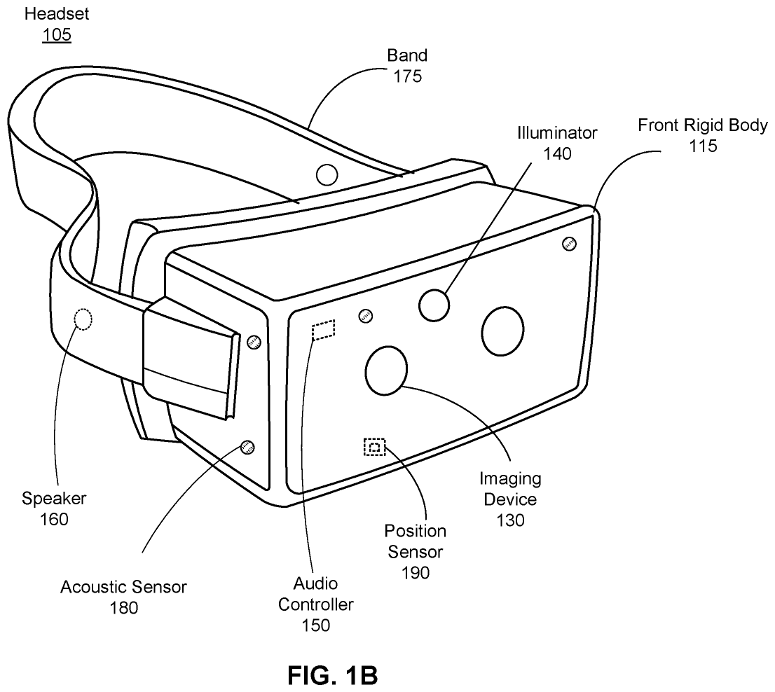

FIG. 1A is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame, and may include, among other components, a display assembly including one or more display elements 120, a depth camera assembly (DCA), an audio system, and a position sensor 190. While FIG. 1A illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1A.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, ear piece).

The one or more display elements 120 provide light to a user wearing the headset 100. As illustrated the headset includes a display element 120 for each eye of a user. In some embodiments, a display element 120 generates image light that is provided to an eyebox of the headset 100. The eyebox is a location in space that an eye of user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eyebox of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eyebox. For example, one or both of the display elements 120 may be a lens without correction (non-prescription) or a prescription lens (e.g., single vision, bifocal and trifocal, or progressive) to help correct for defects in a user's eyesight. In some embodiments, the display element 120 may be polarized and/or tinted to protect the user's eyes from the sun.

In some embodiments, the display element 120 may include an additional optics block (not shown). The optics block may include one or more optical elements (e.g., lens, Fresnel lens, etc.) that direct light from the display element 120 to the eyebox. The optics block may, e.g., correct for aberrations in some or all of the image content, magnify some or all of the image, or some combination thereof.

The DCA determines depth information for a portion of a local area surrounding the headset 100. The DCA includes one or more imaging devices 130 and a DCA controller (not shown in FIG. 1A), and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1A shows a single illuminator 140 and two imaging devices 130. In alternate embodiments, there is no illuminator 140 and at least two imaging devices 130.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof.

The audio system provides audio content. In some embodiments, the audio system includes a transducer array, a sensor array, one or more contact transducers 145, and an audio controller 150. In some embodiments, the one or more contact transducers 145 may include one or more optical microphones configured to monitor and interpret vibrations on skin of a user.

In some embodiments, the audio system may include different and/or additional components. Similarly, in some cases, functionality described with reference to the components of the audio system can be distributed among the components in a different manner than is described here. For example, some or all of the functions of the controller may be performed by a remote server.

The transducer array presents sound to user. The transducer array includes a plurality of transducers. A transducer may be a speaker 160 or a tissue transducer 170 (e.g., a bone conduction transducer or a cartilage conduction transducer). Although the speakers 160 are shown exterior to the frame 110, the speakers 160 may be enclosed in the frame 110. In some embodiments, instead of individual speakers for each ear, the headset 100 includes a speaker array comprising multiple speakers integrated into the frame 110 to improve directionality of presented audio content. The tissue transducer 170 couples to the head of the user and directly vibrates tissue (e.g., bone or cartilage) of the user to generate sound. The number and/or locations of transducers may be different from what is shown in FIG. 1A.

The sensor array detects sounds within the local area of the headset 100. The sensor array includes a plurality of acoustic sensors 180. An acoustic sensor 180 captures sounds emitted from one or more sound sources in the local area (e.g., a room). Each acoustic sensor is configured to detect sound and convert the detected sound into an electronic format (analog or digital). The acoustic sensors 180 may be acoustic wave sensors, microphones, sound transducers, or similar sensors that are suitable for detecting sounds.

In some embodiments, one or more acoustic sensors 180 may be placed in an ear canal of each ear (e.g., acting as binaural microphones). In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1A. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

The audio controller 150 processes information from the sensor array that describes sounds detected by the sensor array. The audio controller 150 may comprise a processor and a computer-readable storage medium. The audio controller 150 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 160, or some combination thereof.

The position sensor 190 generates one or more measurement signals in response to motion of the headset 100. The position sensor 190 may be located on a portion of the frame 110 of the headset 100. The position sensor 190 may include an inertial measurement unit (IMU). Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room.

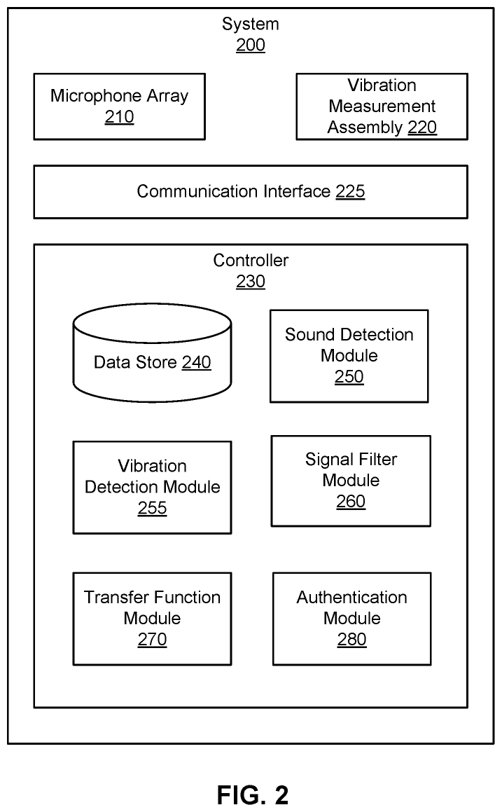

In some embodiments, the controller 150 causes the acoustic sensors 180 to detect airborne acoustic waves corresponding to a vocalization of a user, and causes contact transducers 145 to detect vibrations of tissue of the user caused by the vocalization. The controller 150 generates an authentication dataset based on the detected airborne acoustic waves and the detected vibrations of tissue, and authenticates the user based in part on the authentication dataset. Additional details regarding the components of the headset 100 are discussed below in connection with FIG. 2-6.

FIG. 1B is a perspective view of a headset 105 implemented as an HMD, in accordance with one or more embodiments. In embodiments that describe an AR system and/or an MR system, portions of a front side of the HMD are at least partially transparent in the visible band (˜380 nm to 750 nm), and portions of the HMD that are between the front side of the HMD and an eye of the user are at least partially transparent (e.g., a partially transparent electronic display). The HMD includes a front rigid body 115 and a band 175. The headset 105 includes many of the same components described above with reference to FIG. 1A, but modified to integrate with the HMD form factor. For example, the HMD includes a display assembly, a DCA, an audio system, and a position sensor 190. FIG. 1B shows the illuminator 140, a plurality of the speakers 160, a plurality of the imaging devices 130, a plurality of acoustic sensors 180, a contact transducer 145, and the position sensor 190. The speakers 160 may be located in various locations, such as coupled to the band 175 (as shown), coupled to front rigid body 115, or may be configured to be inserted within the ear canal of a user. The contact transducer 145 may be also located in various locations, such as coupled to a side of the body 115 and/or the band 175 that is in contact with the head or face of the user.

FIG. 2 is a block diagram of an audio system 200. The audio system 200 may be implemented at a headset 100 of FIG. 1A or headset 105 of FIG. 1B. The audio system 200 includes a microphone array 210, a vibration measurement assembly 220, a communication interface 225, and a controller 230. The communication interface 225 allows the audio system 200 to communicate with other devices via wire or wireless communication protocols, such as (but not limited to) Wi-Fi, BLE (Bluetooth low energy), NFC (near field communication), UWB (ultra-wideband), etc. The microphone array 210 may correspond to or be part of the sensor array or acoustic sensors 180 of FIG. 1A or 1B. The vibration measurement assembly 220 may correspond to or be part of the contact transducers 145 of FIG. 1A or 1B. The microphone array 210 is configured to detect airborne acoustic waves. The vibration measurement assembly 220 is configured to detect vibrations of tissue of the user.

The controller 230 includes or has access to a data store 240, a sound detection module 250, a vibration detection module 255, a signal filter module 260, a transfer function module 270, and an authentication module 280. All of the functions performed by various modules 250-280 may be incorporated into different systems (e.g., an authentication system).

The sound detection module 250 is configured to convert airborne acoustic waves detected by the microphone array 210 into sound data. The vibration detection module 255 is configured to convert vibrations of tissue of the user detected by the vibration measurement assembly 220 into vibration data. The data store 240 is configured to store various data associated with software or user. For example, the data store 240 may be configured to store sound data generated by the sound detection module 250 and/or the vibration data generated by the vibration detection module 255.

In some embodiments, the signal filter module 260 is configured to apply various filters to the sound signal or the vibration data for different purposes. For example, in some embodiments, the signal filter module 260 is configured to detect noise from the sound data and vibration data, and filter out the noise from the sound data and the vibration data.

In some embodiments, the signal filter module 260 is further configured to filter the sound data to identify a specific user and/or specific wake words. As an example, the user may use some pre-specified wake words to authenticate and unlock the device. Examples of wake words may include but not limited to, e.g., “Hey Device”, “Hey Facebook”, “Hey Portal”, etc., to activate the audio commanding function. The User may then say “unlock my device,” “unlock my glasses”, etc. Once the user creates these speech commands, the system captures these and creates audio filters using the data concurrently captured by an airborne acoustic microphone or a number of microphones in a mic array and also the vibration measurement system.

In some embodiments, the transfer function module 270 is configured to identify a relationship between the sound data and the vibration data of the user and generate a transfer function, describing the relationship. The combination or relationship of the sound data and vibration data is sufficiently unique for each user, such that it can be used to authenticate users.

The authentication module 280 is configured to authenticate the user based on the sound data, the vibration data, and the relationship therebetween. The authentication module 280 may be activated manually by pressing a button, or automatically based on a detection of a sound. In some embodiments, when the sound detection module 250 and/or the signal filter module 260 detects a vocalization of the user, or a wake word uttered by the user, the authentication module 280 is activated.

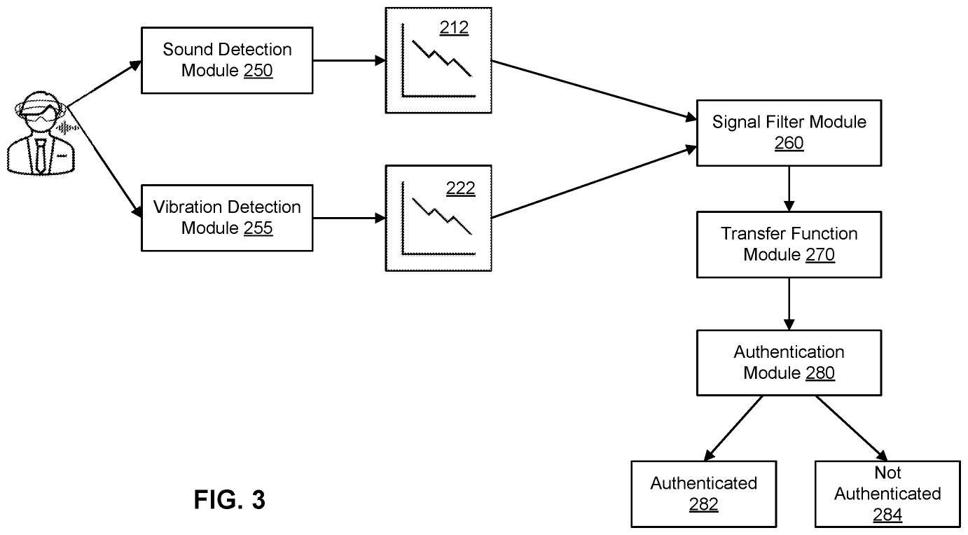

FIG. 3 is a block diagram of an authentication process based on a unique combination of vocalization of a user and vibrations of tissue of the user caused by the vocalization, in accordance with one or more embodiments. As illustrated in FIG. 3, a user may be wearing a headset 100 or 105, which corresponds to the system 200 of FIG. 2. The user may utter a wake word. The microphone array 210 detects airborne acoustic waves corresponding to the uttered wake word, and the sound detection module 250 converts the detected airborne acoustic waves into sound data 212. At the same time, the vibration measurement assembly 220 detects vibrations of skin of the user caused by the utterance of the wake word, and the vibration detection module 255 converts the detected vibrations into vibration data 222.

The detected sound data 212 and vibration data 222 are then processed by the signal filter module 260 and transfer function module 270. The signal filter module 260 may filter the sound data 212 and vibration data 222 to reduce noise. The signal filter module 260 may further filter the sound data 212 to detect a wake word. In some embodiments, responsive to detecting a wake word by the signal filter module 260, the transfer function module 270 generates a transfer function based on the sound data 212 and the vibration data 222. The transfer function describes the relationship between the sound data 212 and the vibration data 222. In some embodiments, the authentication module 280 may compare the generated transfer function with a reference transfer function. When the transfer function and the reference transfer function are sufficiently similar, the authentication module 280 determines that the user is authenticated, represented by box 282. Otherwise, the authentication module 280 determines that the user is not authenticated, represented by box 284. When a user is authenticated or failed to be authenticated, the authentication module 280 may cause the system 200 to generate a feedback, such as a haptic feedback or a voice feedback.

In some embodiments, the comparison between the transfer function and the reference transfer function may include computing a similarity score between the transfer function and the reference function. When the similarity score is greater than a threshold, the authentication module 280 determines that the user is authenticated. In some embodiments, the threshold may be adjusted based on the user configuration. A greater threshold provides a higher security level, although the user may be required to be authenticated several times before successful authentication. A lower threshold provides a lower security level, although the user may be authenticated faster

In some embodiments, the reference transfer function is generated via a voice authentication setup process. For example, the user may be required to be authenticated via a different method, such as using password, or fingerprint, before the voice authentication setup process may start. After the user is authenticated, the system 200 may ask the user to speak one or more wake words once or several times. During the time the user speaks each wake word, the microphone array 210 and sound detection module 250 work together to detect and record sound data; at the same time, the vibration measurement assembly 220 and vibration detection module 255 work together to detect and record vibration data. The recorded sound data and vibration data can then be processed by the transfer function module 270 to generate one or more transfer functions. In some embodiments, each of the transfer functions is separately stored at the system 200 as multiple reference transfer functions. In some embodiments, multiple transfer functions are aggregated (e.g., averaged) into a single transfer function, and the single transfer function is stored at the system 200 as a reference transfer function. In some embodiments, the aggregated single transfer function, and a distribution range of the multiple transfer functions are all recorded at the system 200.

In some embodiments, the audio authentication setup process may be performed via a first device, and the reference transfer function may be stored online at a cloud storage, and used by a second device for authenticating the user.

Alternatively, or in addition, the transfer function module 270 applies a reference transfer function to the sound data 212 to generate second vibration data, and compares the generated vibration data with the detected vibration data 222 to determine whether the user should be authenticated. Alternatively, or in addition, the transfer function module 270 applies a reference transfer function to the vibration data 222 to generate second sound data, and compares the generated sound data with the detected sound data 212 to determine whether the user should be authenticated.

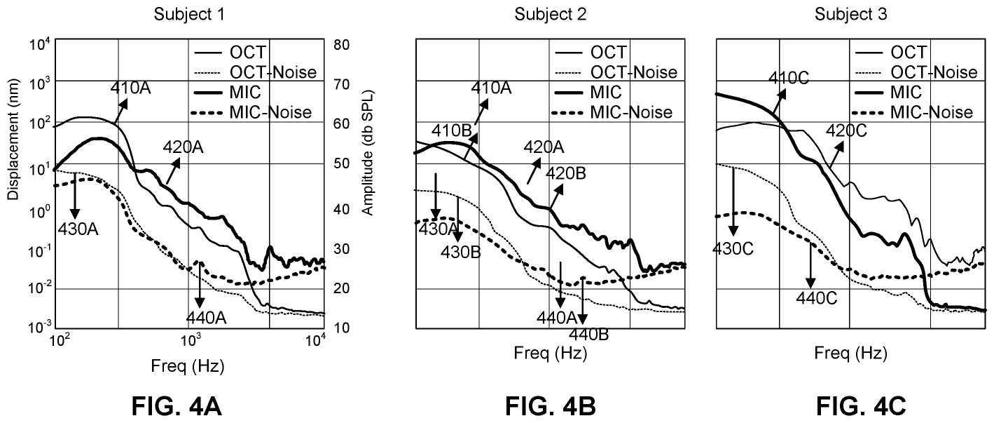

FIG. 4A illustrates a diagram visualizing audio data and vibration data corresponding to a first user (also referred to as “subject 1”), in accordance with one or more embodiments. FIG. 4B illustrates a diagram visualizing audio data and vibration data corresponding to a second user (also referred to as “subject 2”), in accordance with one or more embodiments. FIG. 4C illustrates a diagram visualizing audio data and vibration data corresponding to a third user (also referred to as “subject 3”), in accordance with one or more embodiments. The curves 410A, 410B, 410C in each of FIGS. 4A-4C show the average tissue vibration generated by the subject's speech (measured with vibration detection module 255). The curves 420A, 420B, 420C show the average sound pressure levels (measured with sound detection module 250). Dotted curves 430A, 430B, 430C show the noise floors for the vibration measurement assembly 220 (i.e. signal levels when the subject is silent). The dotted curves 440A, 440B, 440C show the noise floor for the microphone array 210. Note from just the individual data alone, it is apparent that the collected data is quite different for each user.

As illustrated in FIG. 4A, there is a horizontal axis that shows scales of frequency in Hz between 100 to 10,000 (=10⁴) Hz. There are also two vertical axes thereon, one on the left, and the other on the right. The left vertical axis shows scales of displacement (e.g., magnitude of tissue vibrations) in units of nanometers (nm). For example, the displacement or tissue vibration may be between 10⁻³ nm to 10⁴ nm. The right vertical axis shows scales of created sound pressure (e.g., obtained by microphone array 210) in unit of dB SPL (sound pressure level). for example, the sound pressure may be between 10 and 80 dB. Due to space constraints, the vertical scales are not listed in FIG. 4B or 4C, although same vertical axes, scales, and units also apply to them.

In some embodiments, a wake word may be recited by each of the three users a plurality of times. For each user, and each time, during the recitation of the wake word, a microphone array 210 captures a sound signal. A plurality of sound signals (each corresponding to a time of reciting the wake word) may then be averaged to generate an averaged signal. The averaged sound signal may be processed to identify a relationship between the sound pressure levels and different sound frequencies, which may be represented by a curve 420A, 420B, 420C shown in FIGS. 4A-4C. At the same time, when the user recites the wake word, the vibration measurement assembly 220 also captures a vibrations of tissue of the user caused by the vocalization. A plurality of vibration signals (each corresponding to a time of reciting the wake word) may also be averaged to generate an average signal. The averaged vibration signal may also be processed to identify a relationship between tissue displacement levels and different sound frequencies, which may be represented by a curve 410A, 410B, 410C shown in FIGS. 4A-4C.

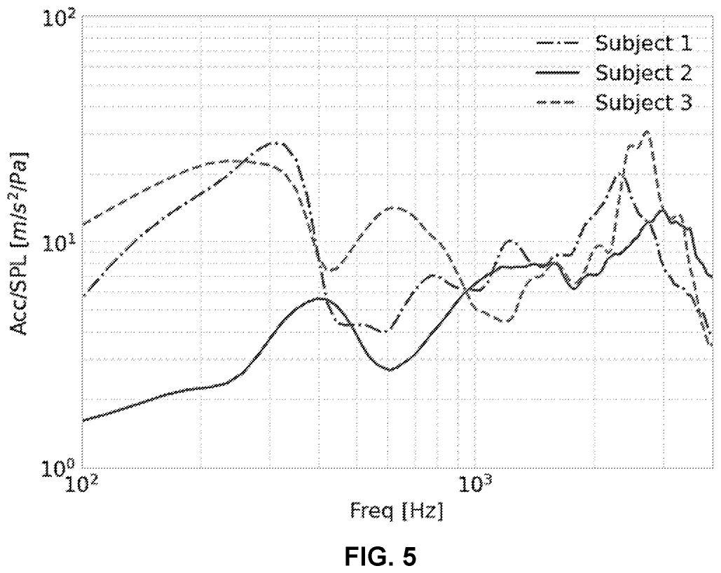

FIG. 5 is a diagram of example relationships between audio frequencies of voice and vibrations of tissue corresponding to three different subjects (e.g., users) shown in FIGS. 4A-4C, in accordance with one or more embodiments. Such relationships may also be represented by transfer functions. The curves in FIG. 5 show the transfer function indicating how much tissue vibration is generated at a given frequency for a particular sound level for each subject. For example, P(f) is a function that denotes the sound pressure levels corresponding to frequency f, and V(f) is a function that denotes the vibration levels corresponding to frequency f. The transfer function may be represented by T(f)=V(f)/P(f). In some embodiments, these sound pressures are created by a user, and can be captured by a headset or glasses using microphones placed and distributed thereon, such as at bottom areas closer to the user's mouth. Each subject corresponds to a different transfer function T(f). Alternatively, the transfer function may be represented by T′(f)=P(f)/V(f). Note that the vibrations of tissue measured from different subjects are different even when they recite the same sentences with the same loudness. Accordingly, the combination or the relationship of the voice data and vibration data for each user is unique and individualized to that user.

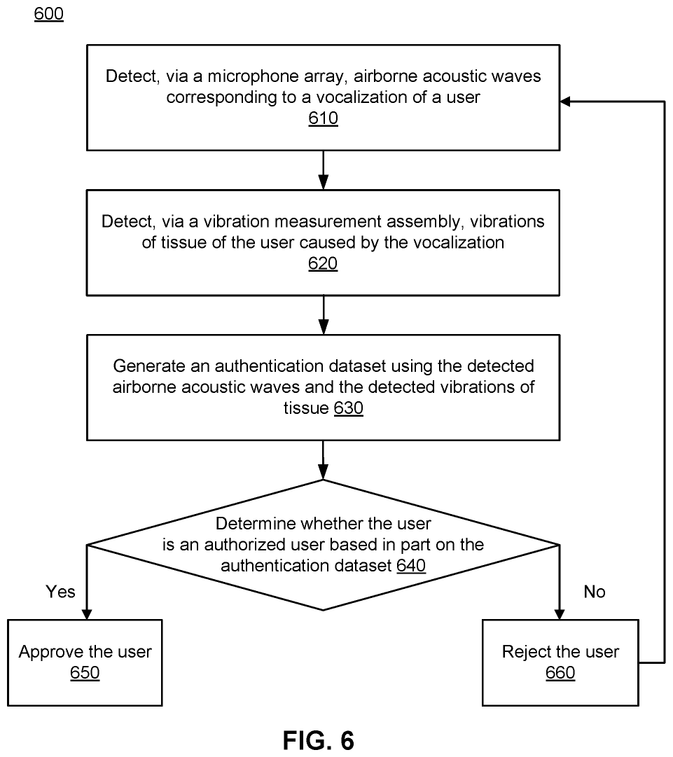

FIG. 6 is a flowchart of a method for authenticating a user based on a unique combination of vocalization of a user and vibrations of tissue of the user caused by the vocalization. The process shown in FIG. 6 may be performed by components of an audio system (e.g., audio system 200). Other entities may perform some or all of the steps in FIG. 6 in other embodiments. Embodiments may include different and/or additional steps, or perform the steps in different orders. The audio system detects 610, via a microphone array (e.g., microphone array 210 of FIG. 2), airborne acoustic waves corresponding to a vocalization of a user. In some embodiments, the detected airborne acoustic waves are converted into sound data. For example, the curves 420A, 420B, 420C shown in FIGS. 4A-4C visualize examples of sound data based on vocalizations of three different users, in accordance with some embodiments.

The computing system detects 620, via a vibration measurement assembly (e.g., vibration measurement assembly 220 of FIG. 2), vibrations of tissue of the user caused by the vocalization. In some embodiments, the detected vibrations are converted into vibration data. For example, the curves 410A, 410B, 410C shown in FIGS. 4A-4C visualize examples of sound data based on vibrations of three different users, in accordance with some embodiments.

The computing system then generates 630 an authentication dataset using the detected airborne acoustic waves and the detected vibration tissue. In some embodiments, the authentication dataset is associated with a transfer function that describes a relationship between the detected airborne acoustic waves and the detected vibration tissue. For example, three curves in FIG. 5 visualize three transfer functions generated based on the sound data and vibration data shown in FIGS. 4A-4C.

The computing system determines 640 whether the user is an authorized user based in part on the authentication dataset. In some embodiments, the authentication dataset is compared with a reference authentication dataset to determine whether the user is an authorized user. In some embodiments, the authentication dataset, and the reference dataset are compared to generate a similarity score. When the similarity score is greater than a predetermined threshold, it is determined that the user is an authorized user.

Responsive to determining that the user is an authorized user, the computing system approves 650 the user. In some embodiments, when the audio system detects a wake word, and determines that the user is an authorized user, the audio system may unlock a device, or grant the user access to requested data. For example, the user utters “hey, device, read aloud my email.” If the audio system determines that the user is an authorized user, the audio system reads the user's email aloud.

Alternatively, responsive to determining that the user is not an authorized user, the computing system rejects 660 the user. For example, the user utters “hey, device, read aloud my email.” If the audio system determines that the user is not authorized user, the audio system may state “you are not authorized to access the content,” or “please try again.”

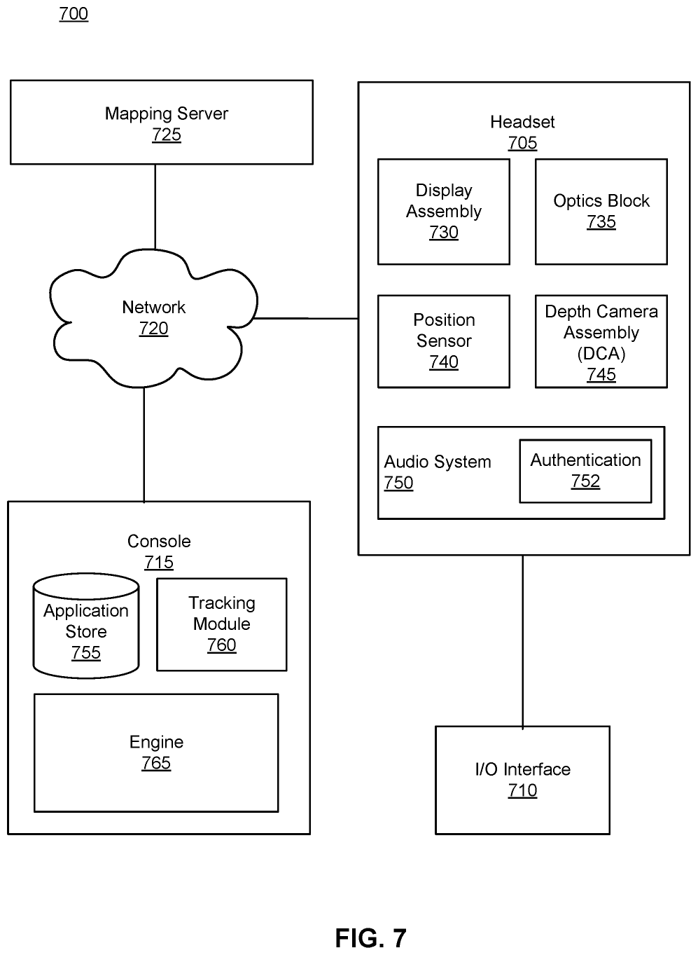

FIG. 7 is a system 700 that includes a headset 705, in accordance with one or more embodiments. In some embodiments, the headset 705 may be the headset 100 of FIG. 1A or the headset 105 of FIG. 1B. The system 700 may operate in an artificial reality environment (e.g., a virtual reality environment, an augmented reality environment, a mixed reality environment, or some combination thereof). The system 700 shown in FIG. 7 includes the headset 705, an input/output (I/O) interface 710 that is coupled to a console 715, the network 720, and the mapping server 725. While FIG. 7 shows an example system 700 including one headset 705 and one I/O interface 710, in other embodiments any number of these components may be included in the system 700. For example, there may be multiple headsets each having an associated I/O interface 710, with each headset and I/O interface 710 communicating with the console 715. In alternative configurations, different and/or additional components may be included in the system 700. Additionally, functionality described in conjunction with one or more of the components shown in FIG. 7 may be distributed among the components in a different manner than described in conjunction with FIG. 7 in some embodiments. For example, some or all of the functionality of the console 715 may be provided by the headset 705.

The headset 705 includes the display assembly 730, an optics block 735, one or more position sensors 740, and the DCA 745, an audio system 750. The audio system 750 has an authentication function 752 configured to authenticate users via various methods, such as voice authentication described above, fingerprint, password, etc. Some embodiments of headset 705 have different components than those described in conjunction with FIG. 7. Additionally, the functionality provided by various components described in conjunction with FIG. 7 may be differently distributed among the components of the headset 705 in other embodiments, or be captured in separate assemblies remote from the headset 705.

The display assembly 730 displays content to the user in accordance with data received from the console 715. The display assembly 730 displays the content using one or more display elements (e.g., the display elements 120). A display element may be, e.g., an electronic display. In various embodiments, the display assembly 730 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element 120 may also include some or all of the functionality of the optics block 735.

The optics block 735 may magnify image light received from the electronic display, corrects optical errors associated with the image light, and presents the corrected image light to one or both eyeboxes of the headset 705. In various embodiments, the optics block 735 includes one or more optical elements. Example optical elements included in the optics block 735 include: an aperture, a Fresnel lens, a convex lens, a concave lens, a filter, a reflecting surface, or any other suitable optical element that affects image light. Moreover, the optics block 735 may include combinations of different optical elements. In some embodiments, one or more of the optical elements in the optics block 735 may have one or more coatings, such as partially reflective or anti-reflective coatings.

Magnification and focusing of the image light by the optics block 735 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 735 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 735 corrects the distortion when it receives image light from the electronic display generated based on the content.

The position sensor 740 is an electronic device that generates data indicating a position of the headset 705. The position sensor 740 generates one or more measurement signals in response to motion of the headset 705. The position sensor 190 is an embodiment of the position sensor 740. Examples of a position sensor 740 include: one or more IMUs, one or more accelerometers, one or more gyroscopes, one or more magnetometers, another suitable type of sensor that detects motion, or some combination thereof. The position sensor 740 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 705 from the sampled data. For example, the IMU integrates the measurement signals received from the accelerometers over time to estimate a velocity vector and integrates the velocity vector over time to determine an estimated position of a reference point on the headset 705. The reference point is a point that may be used to describe the position of the headset 705. While the reference point may generally be defined as a point in space, however, in practice the reference point is defined as a point within the headset 705.

The DCA 745 generates depth information for a portion of the local area. The DCA includes one or more imaging devices and a DCA controller. The DCA 745 may also include an illuminator. Operation and structure of the DCA 745 is described above with regard to FIG. 1A.

The audio system 750 provides audio content to a user of the headset 705. The audio system 750 is substantially the same as the audio system 200 describe above. The audio system 750 may comprise one or acoustic sensors, one or more transducers, and an audio controller. The audio system 750 may provide spatialized audio content to the user. In some embodiments, the audio system 750 may request acoustic parameters from the mapping server 725 over the network 720. The acoustic parameters describe one or more acoustic properties (e.g., room impulse response, a reverberation time, a reverberation level, etc.) of the local area. The audio system 750 may provide information describing at least a portion of the local area from e.g., the DCA 745 and/or location information for the headset 705 from the position sensor 740. The audio system 750 may generate one or more sound filters using one or more of the acoustic parameters received from the mapping server 725, and use the sound filters to provide audio content to the user.

The audio system 750 may correspond the audio system 200 of FIG. 2. The audio system 750 includes authentication function 752 configured to detect, via a microphone array, airborne acoustic waves corresponding to a vocalization of a user; and detects, via a vibration measurement assembly, vibrations of tissue of the user caused by the vocalization. The authentication function 752 then generates an authentication dataset based on the detected airborne acoustic waves and the detected vibrations of tissue, and authenticates the user based in part on the authentication dataset.

The I/O interface 710 is a device that allows a user to send action requests and receive responses from the console 715. An action request is a request to perform a particular action. For example, an action request may be an instruction to start or end capture of image or video data, or an instruction to perform a particular action within an application. The I/O interface 710 may include one or more input devices. Example input devices include: a keyboard, a mouse, a game controller, or any other suitable device for receiving action requests and communicating the action requests to the console 715. An action request received by the I/O interface 710 is communicated to the console 715, which performs an action corresponding to the action request. In some embodiments, the I/O interface 710 includes an IMU that captures calibration data indicating an estimated position of the I/O interface 710 relative to an initial position of the I/O interface 710. In some embodiments, the I/O interface 710 may provide haptic feedback to the user in accordance with instructions received from the console 715. For example, haptic feedback is provided when an action request is received, or the console 715 communicates instructions to the I/O interface 710 causing the I/O interface 710 to generate haptic feedback when the console 715 performs an action.

The console 715 provides content to the headset 705 for processing in accordance with information received from one or more of: the DCA 745, the headset 705, and the I/O interface 710. In the example shown in FIG. 7, the console 715 includes an application store 755, a tracking module 760, and an engine 765. Some embodiments of the console 715 have different modules or components than those described in conjunction with FIG. 7. Similarly, the functions further described below may be distributed among components of the console 715 in a different manner than described in conjunction with FIG. 7. In some embodiments, the functionality discussed herein with respect to the console 715 may be implemented in the headset 705, or a remote system.

The application store 755 stores one or more applications for execution by the console 715. An application is a group of instructions, that when executed by a processor, generates content for presentation to the user. Content generated by an application may be in response to inputs received from the user via movement of the headset 705 or the I/O interface 710. Examples of applications include: gaming applications, conferencing applications, video playback applications, or other suitable applications.

The tracking module 760 tracks movements of the headset 705 or of the I/O interface 710 using information from the DCA 745, the one or more position sensors 740, or some combination thereof. For example, the tracking module 760 determines a position of a reference point of the headset 705 in a mapping of a local area based on information from the headset 705. The tracking module 760 may also determine positions of an object or virtual object. Additionally, in some embodiments, the tracking module 760 may use portions of data indicating a position of the headset 705 from the position sensor 740 as well as representations of the local area from the DCA 745 to predict a future location of the headset 705. The tracking module 760 provides the estimated or predicted future position of the headset 705 or the I/O interface 710 to the engine 765.

The engine 765 executes applications and receives position information, acceleration information, velocity information, predicted future positions, or some combination thereof, of the headset 705 from the tracking module 760. Based on the received information, the engine 765 determines content to provide to the headset 705 for presentation to the user. For example, if the received information indicates that the user has looked to the left, the engine 765 generates content for the headset 705 that mirrors the user's movement in a virtual local area or in a local area augmenting the local area with additional content. Additionally, the engine 765 performs an action within an application executing on the console 715 in response to an action request received from the I/O interface 710 and provides feedback to the user that the action was performed. The provided feedback may be visual or audible feedback via the headset 705 or haptic feedback via the I/O interface 710.

The network 720 couples the headset 705 and/or the console 715 to the mapping server 725. The network 720 may include any combination of local area and/or wide area networks using both wireless and/or wired communication systems. For example, the network 720 may include the Internet, as well as mobile telephone networks. In one embodiment, the network 720 uses standard communications technologies and/or protocols. Hence, the network 720 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 720 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 720 can be represented using technologies and/or formats including image data in binary form (e.g. Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

The mapping server 725 may include a database that stores a virtual model describing a plurality of spaces, wherein one location in the virtual model corresponds to a current configuration of a local area of the headset 705. The mapping server 725 receives, from the headset 705 via the network 720, information describing at least a portion of the local area and/or location information for the local area. The user may adjust privacy settings to allow or prevent the headset 705 from transmitting information to the mapping server 725. The mapping server 725 determines, based on the received information and/or location information, a location in the virtual model that is associated with the local area of the headset 705. The mapping server 725 determines (e.g., retrieves) one or more acoustic parameters associated with the local area, based in part on the determined location in the virtual model and any acoustic parameters associated with the determined location. The mapping server 725 may transmit the location of the local area and any values of acoustic parameters associated with the local area to the headset 705.

In some embodiments, the mapping server 725 may also include a database that stores reference authentication datasets of users that may be used by the authentication function 752 of the audio system 750. For example, in some embodiments, the audio system 750 compares the authentication dataset (generated based on the detected airborne acoustic waves and the detected vibrations of tissue of the user) with a references authentication dataset of the user stored in the mapping server 725. In some embodiments, the audio system 750 allows a user to set up audio authentication. During the setup process, the audio system 750 first authenticates the user via a different method, such as username or fingerprint. After the user is authenticated, the audio system 750 then prompts the user to utter a wake word. The audio system 750 captures airborne acoustic waves and vibrations of tissue of the user during the user's utterance of the wake word, and generates a reference authentication dataset based on the captured airborne acoustic waves and vibrations of tissue. The generated reference authentication dataset may then be stored at the headset 105, the console 715, and/or the mapping server 725. When the authentication dataset is stored at the mapping server 725, the audio system 750 of different headsets may be able to perform audio authentication based on the same reference authentication dataset stored at the mapping server 725.

In some embodiments, one or more components of system 700 may contain a privacy module that stores one or more privacy settings for user data elements. The user data elements describe the user or the headset 705. For example, the user data elements may describe a physical characteristic of the user, an action performed by the user, a location of the user of the headset 705, a location of the headset 705, an HRTF for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 700 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
detecting, via a microphone array, airborne acoustic waves corresponding to a vocalization of a user;
detecting, via a vibration measurement assembly, vibrations of tissue of the user caused by the vocalization;
generating an authentication dataset based on the detected airborne acoustic waves and the detected vibrations of tissue; and
authenticating the user based in part on the authentication dataset.

2. The method of claim 1, wherein generating the authentication dataset using the detected airborne acoustic waves and the detected vibrations of tissue comprises:
generating a transfer function indicating a relationship between amounts of the vibrations of tissue and frequencies of the airborne acoustic waves.

3. The method of claim 1, wherein authenticating the user based in part on the authentication dataset comprises:
comparing the authentication dataset with a reference authentication dataset to determine a similarity; and
responsive to determining that the similarity is within a threshold, determining that the user is authentic.

4. The method of claim 3, further comprising generating the reference authentication dataset, generating the reference authentication dataset including:
authenticating the user via a different method;
detecting, via the microphone array, airborne acoustic waves corresponding to a vocalization of the user;
detecting, via the vibration measurement assembly, vibrations of tissue of the user caused by the vocalization;
generating an authentication dataset using the detected airborne acoustic waves and the detected vibrations of tissue; and
storing the authentication dataset as the reference authentication dataset.

5. The method of claim 3, further comprising receiving the reference authentication dataset from a server.

6. The method of claim 3, further comprising:
monitoring, via the microphone array, surrounding airborne acoustic waves;
detecting a wake word uttered by the user based on the monitored surrounding airborne acoustic waves; and
responsive to detecting the wake word,
extracting the airborne acoustic waves associated with the wake word;
extracting the vibrations of tissue of the user associated with the wake word; and
generating the authentication dataset using the vocalization of the user and the vibrations of tissue of the user associated with the wake word.

7. The method of claim 6, further comprising responsive to authenticating the user based on the wake word, unlocking a device.

8. A non-transitory computer-readable storage medium comprising stored instructions, the instructions when executed by a processor of a device, causing the device to:
detect, via a microphone array, airborne acoustic waves corresponding to a vocalization of a user;
detect, via a vibration measurement assembly, vibrations of tissue of the user caused by the vocalization;
generate an authentication dataset based on the detected airborne acoustic waves and the detected vibrations of tissue; and
authenticate the user based in part on the authentication dataset.

9. The non-transitory computer-readable storage medium of claim 8, further comprises instructions when executed cause the device to:
generate a transfer function indicating a relationship between amounts of the vibrations of tissue and frequencies of the airborne acoustic waves.

10. The non-transitory computer-readable storage medium of claim 8, further comprising stored instructions that when executed cause the device to:
compare the authentication dataset with a reference authentication dataset to determine a similarity; and
responsive to determining that the similarity is within a threshold, determine that the user is authentic.

11. The non-transitory computer-readable storage medium of claim 10, further comprising stored instructions that when executed cause the device to:
authenticate the user via a different method;
detect, via the microphone array, airborne acoustic waves corresponding to a vocalization of the user;
detect, via the vibration measurement assembly, vibrations of tissue of the user caused by the vocalization;
generate an authentication dataset using the detected airborne acoustic waves and the detected vibrations of tissue; and
store the authentication dataset as the reference authentication dataset.

12. The non-transitory computer-readable storage medium of claim 10, further comprising stored instructions that when executed cause the device to receive the reference authentication dataset from a server.

13. The non-transitory computer-readable storage medium of claim 10, further comprising stored instructions that when executed cause the device to:
monitor, via the microphone array, surrounding airborne acoustic waves;
detect a wake word uttered by the user based on the monitored surrounding airborne acoustic waves; and
responsive to detecting the wake word,
extract the airborne acoustic waves associated with the wake word;
extract the vibrations of tissue of the user associated with the wake word; and
generate the authentication dataset using the vocalization of the user and the vibrations of tissue of the user associated with the wake word.

14. The non-transitory computer-readable storage medium of claim 13, further comprising stored instructions that when executed cause the device to: unlock the device responsive to authenticating the user based on the wake word.

15. A system comprising:
a microphone array;
a vibration measurement assembly; and
a controller configured to:
detect, by the microphone array, airborne acoustic waves corresponding to a vocalization of a user,
detect, by the vibration measurement assembly, vibrations of tissue of the user caused by the vocalization,
generate an authentication dataset based on the detected airborne acoustic waves and the detected vibrations of tissue, and
authenticate the user based in part on the authentication dataset.

16. The system of claim 15, wherein the controller is further configured to:
generate a transfer function indicating a relationship between amounts of the vibrations of tissue and frequencies of the airborne acoustic waves.

17. The system of claim 15, wherein the controller is further configured to:
compare the authentication dataset with a reference authentication dataset to determine a similarity; and
responsive to a determination that the similarity is within a threshold, determine that the user is authentic.

18. The system of claim 17, wherein the controller is further configured to:
authenticate the user via a different method;
detect, by the microphone array, airborne acoustic waves corresponding to a vocalization of the user;
detect, via the vibration measurement assembly, vibrations of tissue of the user caused by the vocalization;
generate an authentication dataset using the detected airborne acoustic waves and the detected vibrations of tissue; and
store the authentication dataset as the reference authentication dataset.

19. The system of claim 17, wherein the controller is further configured to receive the reference authentication dataset from a server.

20. The system of claim 17, wherein the controller is further configured to:
monitor, by the microphone array, surrounding airborne acoustic waves;
detect a wake word uttered by the user based on the monitored surrounding airborne acoustic waves; and
responsive to a detection of the wake word,
extract the airborne acoustic waves associated with the wake word,
extract the vibrations of tissue of the user associated with the wake word, and
generate the authentication dataset using the vocalization of the user and the vibrations of tissue of the user associated with the wake word.
